(19) United States
(12) Patent Application Publication
(10) Pub. No.: US 2018/0232780 A1
(43) Pub. Date: Aug. 16, 2018

(54) DETERMINATION METHOD, DETERMINATION APPARATUS, AND NON-TRANSITORY COMPUTER-READABLE STORAGE MEDIUM

(71) Applicant: YAHOO JAPAN CORPORATION, Tokyo (JP)

(72) Inventors: Yuki TAKI, Tokyo (JP); Shunsaku ASANO, Tokyo (JP)

(73) Assignee: YAHOO JAPAN CORPORATION, Tokyo (JP)

(21) Appl. No.: 15/868,369

(22) Filed: Jan. 11, 2018

(30) Foreign Application Priority Data
Feb. 16, 2017 (JP) 2017-027309

(51) Int. Cl. G06Q 30/02

(52) U.S. Cl. CPC G06Q 30/0275; G06Q 30/0272

(57) ABSTRACT

A determination method according to the present application comprises acquiring a first advertisement from a first type advertisement distribution server that has a predetermined relationship with content that includes a predetermined ad spot displayed on a terminal device, requesting, by sending amount-of-money information that is based on a condition related to the first type advertisement distribution server, distribution of an advertisement from a second type advertisement distribution server, and determining, when the second advertisement has been acquired from the second type advertisement distribution server, to display the second advertisement on the ad spot and determines, when the second advertisement has not been acquired from the second type advertisement distribution server, to display the first advertisement on the ad spot.

### CROSS-REFERENCE TO RELATED APPLICATION(S)

The present application claims priority to and incorporates by reference the entire contents of Japanese Patent Application No. 2017-027309 filed in Japan on Feb. 16, 2017.

### BACKGROUND OF THE INVENTION

### 1. Field of the Invention

The present invention relates to a determination method, a determination apparatus, and a non-transitory computer-readable storage medium having stored therein a determination program.

### 2. Description of the Related Art

In recent years, there is a known method that distributes advertisements via a predetermined advertisement distribution platform. As such an advertisement distribution platform, for example, there are known ad networks that are networks each of which distributes advertisements to a lot of media that are targeted for distribution of the advertisements.

Patent Document 1: Japanese Laid-open Patent Publication No. 2016-139198

However, in the conventional technology described above, it is difficult to appropriately determine an advertisement to be displayed. For example, it is sometimes difficult to increase profitability only by simply displaying advertisements acquired from ad networks. For example, if an advertisement is displayed on a certain medium (content), even if an advertisement with profitability higher than an advertisement of an ad network, if the advertisement acquired from the ad network is simply determined as an advertisement to be displayed, it is difficult to determine an appropriate advertisement as the advertisement to be displayed in terms of profitability or the like.

### SUMMARY OF THE INVENTION

It is an object of the present invention to at least partially solve the problems in the conventional technology.

According to one aspect of an embodiment, a determination method performed by a computer comprises acquiring a first advertisement from a first type advertisement distribution server that has a predetermined relationship with content that includes a predetermined ad spot displayed on a terminal device, requesting, by sending amount-of-money information that is based on a condition related to the first type advertisement distribution server, distribution of an advertisement from a second type advertisement distribution server that determines an advertisement to be distributed in accordance with a bid price of each advertisement and that distributes a second advertisement when a bid price of the second advertisement satisfies the condition that is based on the amount-of-money information, and determining, when the second advertisement has been acquired from the second type advertisement distribution server, to display the second advertisement on the ad spot and determining, when the second advertisement has not been acquired from the second type advertisement distribution server, to display the first advertisement on the ad spot.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a determination process according to an embodiment;

FIG. 2 is a diagram illustrating a configuration example of the determination system according to the embodiment;

FIG. 3 is a diagram illustrating a configuration example of a terminal device according to the embodiment;

FIG. 4 is a diagram illustrating an example of an advertisement information storage unit according to the embodiment;

FIG. 5 is a flowchart illustrating an example of a determination process according to the embodiment;

FIG. 6 is a diagram illustrating an example of the determination process according to the embodiment;

FIG. 7 is a diagram illustrating an example of an association table according to the embodiment;

FIG. 8 is a diagram illustrating an example of an advertisement request performed by using the association table according to the embodiment;

FIG. 9 is a diagram illustrating an example of an advertisement request performed by using the association table according to the embodiment; and

FIG. 10 is a hardware configuration diagram illustrating an example of a computer that implements the function of the terminal device.

### DETAILED DESCRIPTION OF THE PREFERRED EMBODIMENTS

A mode (hereinafter, referred to as an “embodiment”) for carrying out a non-transitory computer-readable storage medium having stored therein a determination program, a determination method, and a determination apparatus according to the present application will be described in detail below with reference to the accompanying drawings. The non-transitory computer-readable storage medium having stored therein the determination program, the determination method, and the determination apparatus according to the present application are not limited by the embodiment. Furthermore, in the embodiments below, the same components are denoted by the same reference numerals and overlapping descriptions will be omitted.

### 1. Determination Process

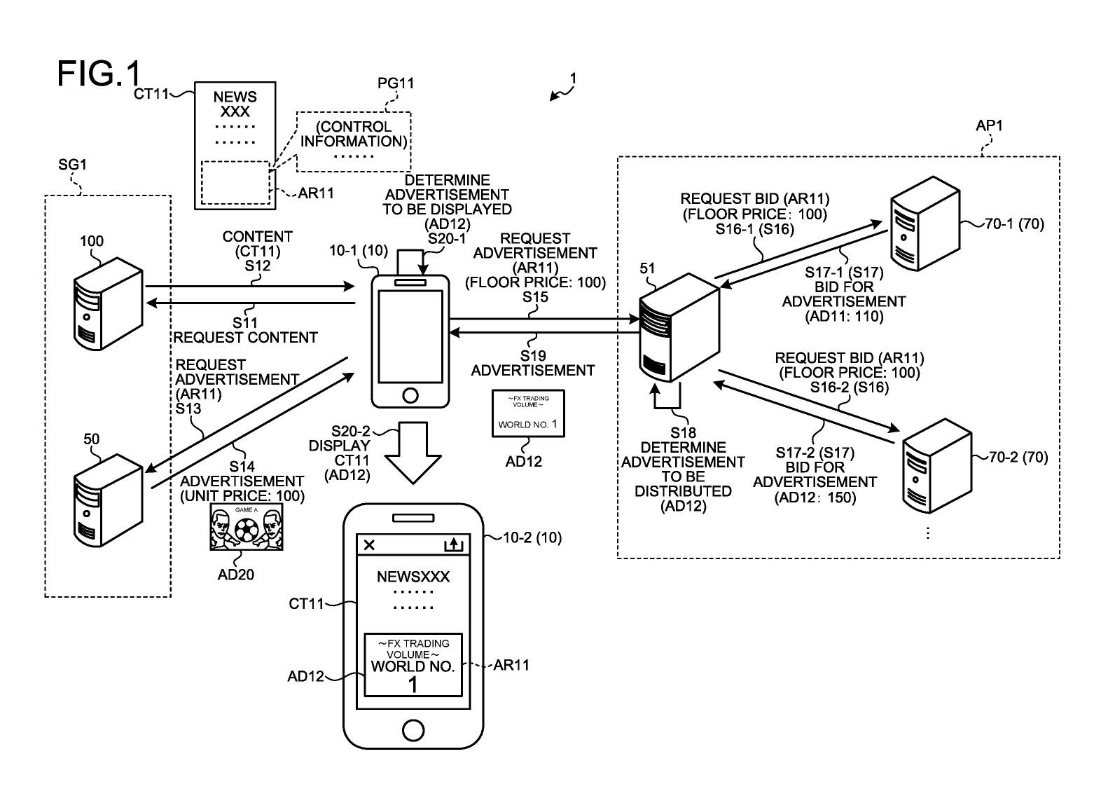

First an example of a determination process according to the embodiment will be described with reference to FIG. 1. FIG. 1 is a diagram illustrating an example of the determination process according to an embodiment. FIG. 1 illustrates a case in which a terminal device 10 requests content from a content distribution device 100 and determines an advertisement to be displayed on an advertisement display area (ad spot) that is included in the content.

### Configuration of Determination System

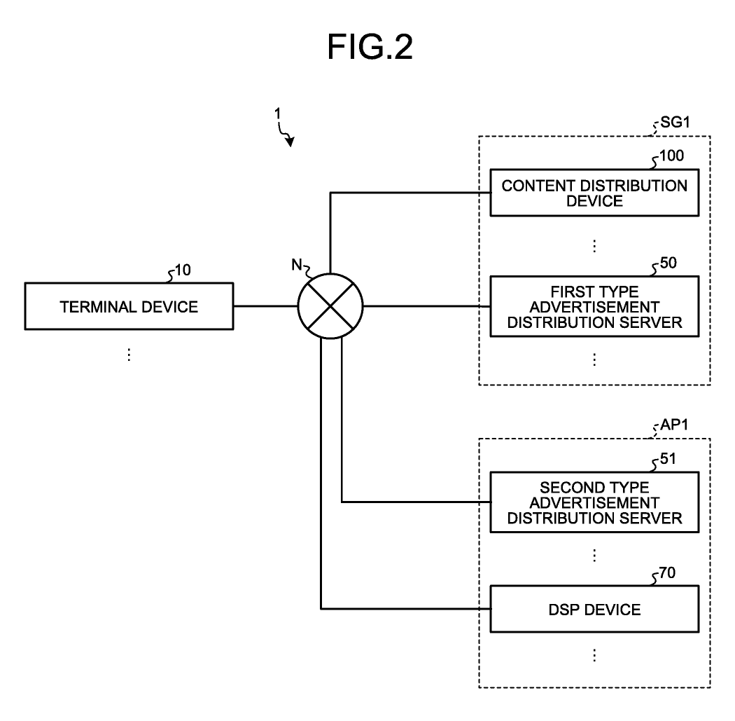

Before a description of the determination process illustrated in FIG. 1, a determination system 1 illustrated in FIGS. 1 and 2 will be described. FIG. 2 is a diagram illustrating a configuration example of the determination system according to the embodiment. As illustrated in FIG. 2, the determination system 1 includes the terminal device 10, the content distribution device 100, a first type advertisement distribution server 50, a second type advertisement distribution server 51, DSP devices 70-1 and 70-2, and the like. In a description below, the DSP devices 70-1 and 70-2 are referred to as a DSP device 70 as long as the DSP devices 70-1 and 70-2 need not be distinguished. Furthermore, the terminal device 10, the content distribution device 100, the first type advertisement distribution server 50, the second type advertisement distribution server 51, and the DSP device 70 are connected via a predetermined network N such that the devices can be communicated with each other in a wired or wireless manner. Furthermore, in the determination system 1 illustrated in FIG. 2, a plurality of the terminal devices 10, a plurality of the content distribution devices 100, a plurality of the first type advertisement distribution servers 50, and a plurality of the second type advertisement distribution servers 51 may also be included.

The terminal device 10 is an information processing apparatus used by a user. In a description below, the terminal device 10 is sometimes referred to as a user. Namely, in a description below, a user can also be read as the terminal device 10. Furthermore, the terminal device 10 is implemented by, for example, a smart phone, a tablet terminal, a notebook personal computer (PC), a desktop PC, a mobile phone, a personal digital assistant (PDA), or the like. The example illustrated in FIG. 1 indicates a case in which the terminal device 10 is a smart phone having a touch panel function. For example, the example illustrated in FIG. 1 illustrates a case in which the terminal device 10 is a smart phone that is used by a user identified by a user ID of “U1” (hereinafter, sometimes referred to as a “user U1”).

The terminal device 10 receives an operation performed by a user. For example, the terminal device 10 starts up various applications (hereinafter, also be referred to as an “app”), such as browsers operated by the user. The example illustrated in FIG. 1 indicates a case in which the terminal device 10 displays content by a browser. Then, the terminal device 10 requests content from the content distribution device 100 by an operation performed by the user. Furthermore, the terminal device 10 requests an advertisement to be displayed on a display frame that is included in the content from the first type advertisement distribution server 50 or the second type advertisement distribution server 51.

Furthermore, in accordance with a change in display content in the terminal device 10, a description will be given by using the terminal device 10 as terminal devices 10-1 and 10-2. Furthermore, the terminal devices 10-1 and 10-2 are the same terminal device 10. Furthermore, in a description below, the terminal devices 10-1 and 10-2 are referred to as the terminal device 10 as long as the terminal devices 10-1 and 10-2 need not be distinguished.

The content distribution device 100 is an information processing apparatus that distributes content. In the example illustrated in FIG. 1, the content distribution device 100 distributes content to be displayed on the terminal device 10 in response to a request from the terminal device 10.

The first type advertisement distribution server 50 is known as a so-called ad network and is an information processing apparatus that distributes an advertisement through the networks, each of which distribute advertisements to a lot of media that are targeted for distribution of the advertisements. Furthermore, the first type advertisement distribution server 50 is an information processing apparatus that distributes an advertisement in response to a distribution request for an advertisement (hereinafter, also referred to as an “advertisement request”) received from the terminal device 10. For example, the first type advertisement distribution server 50 distributes an advertisement to be displayed on an ad spot included in content that is distributed by the content distribution device 100. For example, the first type advertisement distribution server 50 is an advertisement distribution server related to an ad network that distributes an advertisement to be displayed on an ad spot of the content that is distributed by the content distribution device 100.

For example, the first type advertisement distribution server 50 is an advertisement distribution server with a first type that has a predetermined relationship with the content that is distributed by the content distribution device 100. For example, the first type advertisement distribution server 50 is a server in which the content distributed by the content distribution device 100 is set as an advertisement distribution target.

For example, the first type advertisement distribution server 50 is an advertisement distribution server that is used by a providing source that has a predetermined relationship with a providing source that distributes content. For example, the first type advertisement distribution server 50 is an advertisement distribution server that is used by a providing source that has a predetermined relationship with a providing source of the content distribution device 100. For example, the first type advertisement distribution server 50 is an advertisement distribution server that is used by a providing source that distributes content to provide an advertisement distribution service. For example, the first type advertisement distribution server 50 is an advertisement distribution server that is used by a providing source of the content distribution device 100 to provide an advertisement distribution service.

In the example illustrated in FIG. 1, the first type advertisement distribution server 50 is an advertisement distribution server belonging to a same service group SG1 to which the content distribution device 100 belongs. Specifically, the first type advertisement distribution server 50 is an advertisement distribution server that is used by a providing source that provides the same service as that provided by the content distribution device 100 and is an advertisement distribution server that distributes an advertisement on the content distributed by the content distribution device 100.

The second type advertisement distribution server 51 provides an advertisement distribution service that distributes an advertisement in response to an advertisement request. For example, the second type advertisement distribution server 51 is an advertisement distribution device in a supply-side platform (SSP) that is a platform that increases the profit on the medium side. For example, the second type advertisement distribution server 51 in the SSP requests a bid from a predetermined platform (for example, a demand-side platform (DSP)), acquires a bid for an advertisement desired to be distributed from each DSP device (the DSP devices 70), and determines, based on the acquired advertisements, an advertisement to be distributed.

For example, the second type advertisement distribution server 51 requests, from each of the DSP devices 70, a bid for an advertisement that becomes a candidate for distribution in response to an advertisement request received from the terminal device 10. For example, if the second type advertisement distribution server 51 receives an advertisement request that is associated with a plurality of ad spots, the second type advertisement distribution server 51 acquires an advertisement in accordance with each of the ad spots and determines an advertisement to be distributed (hereinafter, also referred to as a “distribution advertisement”). For example, the second type advertisement distribution server 51 determines an advertisement to be distributed in accordance with a bid price of each of the advertisements. Furthermore, for example, the second type advertisement distribution server 51 distributes a second advertisement when the bid price of the second advertisement satisfies the condition that is based on amount-of-money information.

The DSP device 70 is a device that submits a bid for an advertisement in response to a request received from the second type advertisement distribution server 51. In the example illustrated in FIG. 1, the DSP device 70 is a device belonging to the same advertisement distribution platform AP1 to which the second type advertisement distribution server 51 belongs. For example, the DSP device 70 is an advertisement providing server that becomes the providing source of an advertisement to be provided. Furthermore, the DSP device 70 mentioned here indicates a device that submits a bid for an advertisement in response to a bid request received from the second type advertisement distribution server 51. Namely, the DSP device 70 submits a bid for an advertisement by designating a bid amount with respect to a bid request received from the second type advertisement distribution server 51. Furthermore, the second type advertisement distribution server 51 can determine, as a distribution advertisement, a desired advertisement from among the advertisements that were bid by the DSP device 70.

In the following, the determination process performed in the determination system 1 will be described with reference to FIG. 1. In the example illustrated in FIG. 1, the terminal device 10-1 sends, in accordance with an operation performed by a user, a request for content to the content distribution device 100 (Step S11). The content distribution device 100 that has received the request for the content distributes the content to be displayed on the terminal device 10 (Step S12).

For example, the content distribution device 100 distributes content CT11 to the terminal device 10. In the example illustrated in FIG. 1, the content distribution device 100 distributes the content CT11 including control information PG11 that executes the determination process. For example, the control information PG11 includes the determination program that is JavaScript (registered trademark) and that causes the terminal device 10 to execute the determination process. Furthermore, the control information PG11 may also be previously distributed to the terminal device 10 before the process at Step S12 is performed. Furthermore, for example, if the terminal device 10 uses a dedicated application that displays the content distributed by the content distribution device 100, a predetermined software development kit (SDK) that performs the determination process may also be included in the dedicated application. For example, the determination program that causes the terminal device 10 to execute the determination process is included in the SDK of the dedicated application.

At Step S12, the terminal device 10-1 that has received the content CT11 requests, from the first type advertisement distribution server 50, an advertisement that is to be displayed on an ad spot AR11 that is included in the content CT11 (Step S13). For example, the terminal device 10-1 requests an advertisement from the first type advertisement distribution server 50 by using the control information PG11. In the example illustrated in FIG. 1, by sending information indicating the ad spot AR11 to the first type advertisement distribution server 50, the terminal device 10-1 requests an advertisement from the first type advertisement distribution server 50.

The first type advertisement distribution server 50 that has received the request for the advertisement from the terminal device 10 distributes a first advertisement to the terminal device 10 (Step S14). In the example illustrated in FIG. 1, the first type advertisement distribution server 50 distributes the advertisement identified by an advertisement ID of “AD20” (hereinafter, also referred to as an “advertisement AD20”) to the terminal device 10. Furthermore, in the example illustrated in FIG. 1, the first type advertisement distribution server 50 sends information indicating that the unit price of the advertisement AD20 is “100 (yen)” to the terminal device 10. For example, the unit price of the advertisement AD20 mentioned here may also be a billing amount billed to an advertiser of the advertisement AD20 when the advertisement AD20 is displayed. Furthermore, a description below indicates a case in which the terminal device 10 uses the unit price “100 (yen)” of the advertisement AD20 as a floor price that indicates the lowest amount of money for a successful bid for the right to display the advertisement on the ad spot AR11. Furthermore, in an advertisement information storage unit 141 illustrated in FIG. 4, the unit price is illustrated in order to indicate that information related to the unit price of an advertisement is stored in the terminal device 10; however, it may also unable to acquire the unit price on a plane (content) in which the control information PG11 is packaged. For example, the information related to the unit price of an advertisement may also be unable to be acquired, as information of JavaScript or SDK as the control information PG11, by a user who uses the terminal device 10 or by another application or the like that does not use the control information PG11 stored in the terminal device 10.

The terminal device 10-1 that has acquired the advertisement AD20 and the information indicating the unit price thereof from the first type advertisement distribution server 50 requests an advertisement from the advertisement distribution platform AP1 (Step S15). In the example illustrated in FIG. 1, the terminal device 10-1 requests an advertisement by sending the information indicating the ad spot AR11 and the information indicating that the floor price is “100 (yen)” to the second type advertisement distribution server 51 that belongs to the advertisement distribution platform AP1.

The second type advertisement distribution server 51 that has acquired the advertisement request from the terminal device 10 requests a bid for an advertisement with the minimum bid amount of money of “100 (yen)” from the DSP device 70 that belongs to the advertisement distribution platform AP1 (Step S16).

In the example illustrated in FIG. 1, regarding the ad spot AR11, the second type advertisement distribution server 51 requests a bid for an advertisement with the minimum bid amount of money of “100 (yen)” from the DSP device 70-1 (Step S16-1). Furthermore, in the example illustrated in FIG. 1, regarding the ad spot AR11, the second type advertisement distribution server 51 requests a bid for an advertisement with the minimum bid amount of money of “100 (yen)” from the DSP device 70-2 (Step S16-2). Furthermore, although not illustrated in FIG. 1, the second type advertisement distribution server 51 also requests a bid for an advertisement from the other DSP devices 70.

Then, at Step S16, each of the DSP devices 70 that has acquired the bid request submits a bit for an advertisement to the second type advertisement distribution server 51 (Step S17). In the example illustrated in FIG. 1, the DSP device 70-1 designates a bid amount “110 (yen)” that is higher than the minimum bid amount of money “100 (yen)” and submits a bit for the advertisement identified by an advertisement ID of “AD11” (hereinafter, also referred to as an “advertisement AD11”) to the second type advertisement distribution server 51 (Step S17-1). In the example illustrated in FIG. 1, the DSP device 70-2 designates a bid amount “150 (yen)” that is higher than the minimum bid amount of money “100 (yen)” and submits a bit for the advertisement identified by an advertisement ID “AD12” (hereinafter, also referred to as an “advertisement AD12”) to the second type advertisement distribution server (Step S17-2). Furthermore, although not illustrated in FIG. 1, the second type advertisement distribution server 51 similarly receives a bid for an advertisement from the other DSP devices 70. Furthermore, each of the DSP devices 70 that responds to the bid request received from the second type advertisement distribution server 51 may also send a bid advertisement itself or may also send information related to the bid advertisement, such as information for identifying the bid advertisement or information related to a bid amount. Furthermore, each of the DSP devices 70 does not need to submit a bid for an advertisement and this point will be described later in detail.

Then, the second type advertisement distribution server 51 determines a second advertisement to be distributed to the ad spot AR11 (Step S18). For example, the second type advertisement distribution server 51 determines the advertisement with the maximum bid amount as the second advertisement to be displayed on the ad spot AR11. In the example illustrated in FIG. 1, the second type advertisement distribution server 51 determines the advertisement AD12 with the maximum bid amount of “150 (yen)” as the second advertisement that is to be distributed to the ad spot AR11. Furthermore, the above description is an example and the second type advertisement distribution server 51 may also determine the second advertisement to be distributed to the ad spot AR11 based on another advertisement evaluation value, such as effective cost per mille (eCPM), from among the advertisements each having a bid amount that is higher than the minimum bid amount of money “100 (yen)”. Furthermore, a process performed when a bid advertisement is not present will be described later.

At Step S18, the second type advertisement distribution server 51 that has determined the distribution advertisement distributes the advertisement AD12 as the advertisement to be displayed on the ad spot AR11 (Step S19).

The terminal device 10-1 that has received the distribution advertisement determines, in accordance with reception from the second type advertisement distribution server 51, the advertisement to be displayed (Step S20-1). For example, if the terminal device 10-1 acquires the second advertisement from the second type advertisement distribution server 51, the terminal device 10-1 determines to display the second advertisement on the ad spot.

Thus, in the example illustrated in FIG. 1, the terminal device 10 determines the advertisement AD12 acquired from the second type advertisement distribution server 51 as the advertisement to be displayed on the ad spot AR11. Then, the terminal device 10-2 displays the content CT11 in which the advertisement AD12 is arranged in the ad spot AR11 (Step S20-2). In the example illustrated in FIG. 1, the terminal device 10-2 displays, on the ad spot AR11, the advertisement AD12 related to foreign exchange margin trading (foreign exchange: FX).

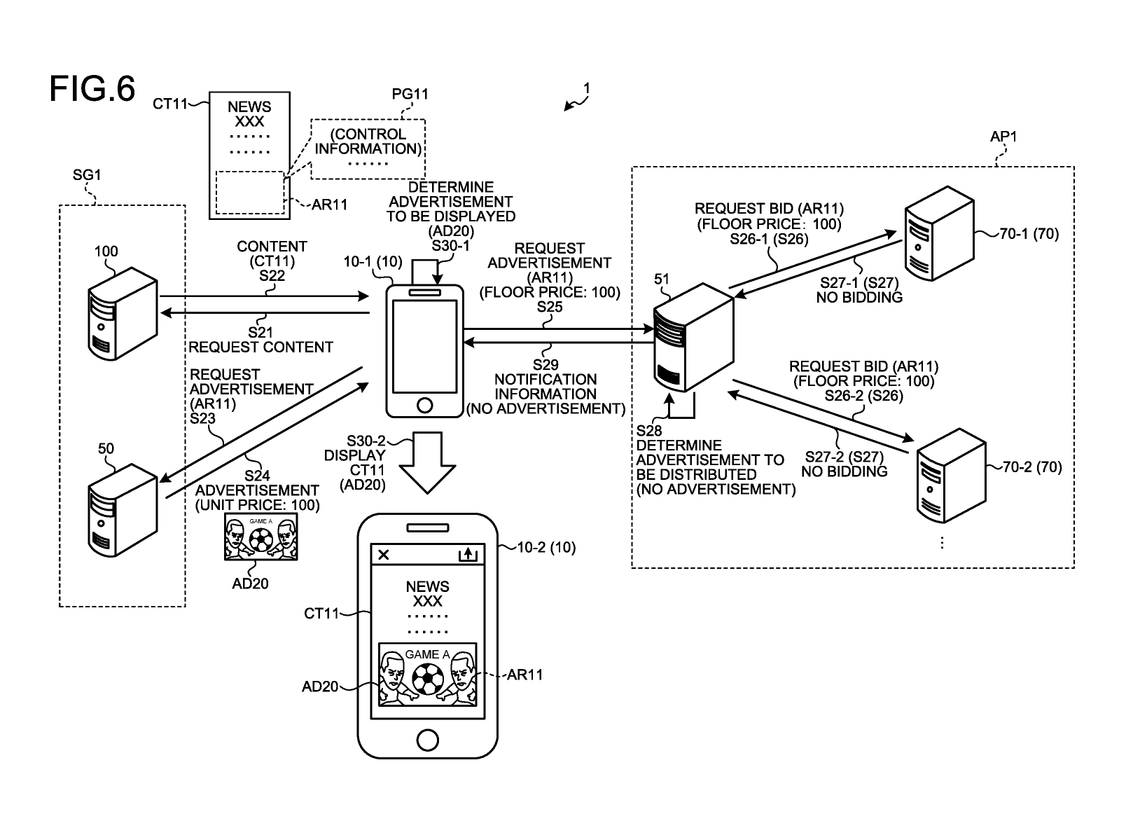

As described above, the terminal device 10 requests an advertisement from the second type advertisement distribution server 51 by designating a floor price and determines the advertisement that is to be displayed on the ad spot AR11 in accordance with a response received from the second type advertisement distribution server 51, whereby the terminal device 10 can appropriately determine the advertisement to be displayed. Here, the advertisement AD12 distributed by the second type advertisement distribution server 51 is the advertisement with the bid amount of “150 (yen)” that is higher than the floor price “100 (yen)”. Consequently, a profit is increased in distribution of the advertisement to the content CT11 in the case where the advertisement AD12 is displayed on the ad spot AR11 when compared with a case in which the advertisement AD20 with the unit price “100 (yen)” acquired from the first type advertisement distribution server 50 is displayed on the ad spot AR11. Thus, the terminal device 10 displays the advertisement distributed from the second type advertisement distribution server 51 on the ad spot AR11, instead of the advertisement to be distributed from the first type advertisement distribution server 50 in which the normal content CT11 is set as the target for advertisement distribution. Consequently, the determination system 1 can increase the profitability of the advertisement distribution. Furthermore, if the terminal device 10 has not acquired the second advertisement from the second type advertisement distribution server, the terminal device 10 determines that the first advertisement is to be displayed on the ad spot and this point will be described in detail later with reference to FIG. 6.

### Entity of Determination Process

Furthermore, in the example described above, a case in which an advertisement to be displayed on the ad spot AR11 in the content CT11 is determined in the terminal device 10 has been described; however, the advertisement to be displayed on the ad spot AR11 in the content CT11 may also be determined in any one of the devices in the determination system 1.

For example, in the determination system 1, the content distribution device 100 may also determine the advertisement to be displayed on the ad spot AR11 in the content CT11. In this case, the content distribution device 100 may also be a determination apparatus that performs the determination process. Furthermore, the content distribution device 100 may also be a computer that executes a determination program. The process in this case will be briefly described below.

For example, if the content distribution device 100 acquires a distribution request for the content CT11 from the terminal device 10, the content distribution device 100 requests an advertisement from the first type advertisement distribution server 50 and acquires the first advertisement from the first type advertisement distribution server 50. Furthermore, the content distribution device 100 acquires the unit price of the first advertisement from the first type advertisement distribution server 50.

Then, the content distribution device 100 requests the second advertisement from the second type advertisement distribution server 51 by sending, to the second type advertisement distribution server 51 that belongs to the advertisement distribution platform AP1, the information that indicates the ad spot AR11 and the floor price information that is based on the unit price of the first advertisement.

Then, if the content distribution device 100 has acquired the second advertisement from the second type advertisement distribution server 51, the content distribution device 100 determines that the second advertisement is displayed on the ad spot AR11. In this case, for example, the content distribution device 100 arranges the second advertisement in the ad spot AR11 in the content CT11 and distributes the content CT11 to the terminal device 10.

In contrast, if the content distribution device 100 has not acquired the second advertisement from the second type advertisement distribution server 51, the content distribution device 100 determines that the first advertisement is displayed on the ad spot AR11. In this case, for example, the content distribution device 100 arranges the first advertisement in the ad spot AR11 in the content CT11 and distributes the content CT11 to the terminal device 10. In this way, when the content distribution device 100 performs the determination process, the content distribution device 100 can determine the advertisement to be displayed on the ad spot AR11 in the content CT11 without sending the information related to an advertisement fee to the side of the terminal device 10. In this way, even if the content distribution device 100 performs the determination process, the determination system 1 can appropriately determine an advertisement that is to be displayed on the terminal device 10.

### 2. Configuration of Terminal Device

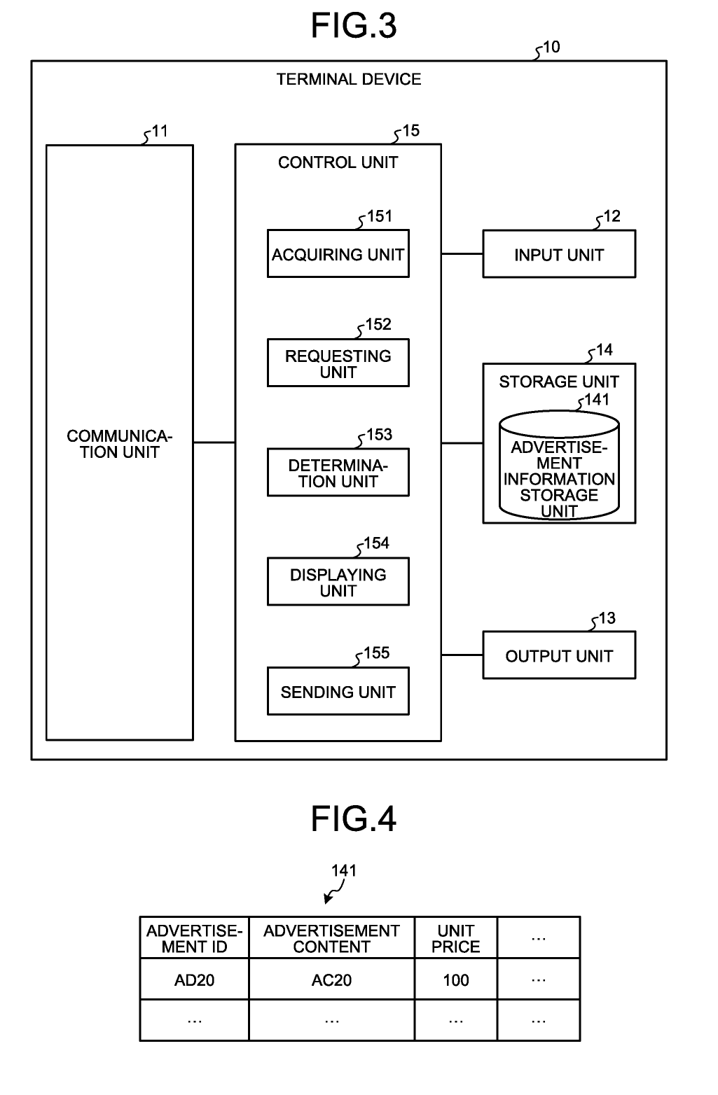

In the following, the configuration of the terminal device 10 according to the embodiment will be described with reference to FIG. 3. FIG. 3 is a diagram illustrating a configuration example of a terminal device according to the embodiment. As illustrated in FIG. 3, the terminal device 10 includes a communication unit 11, an input unit 12, an output unit 13, a storage unit 14, and a control unit 15.

### Communication Unit 11

The communication unit 11 is implemented by, for example, a communication circuit, or the like. Then, the communication unit 11 is connected to a predetermined communication network (not illustrated) in a wired or wireless manner and sends and receives information to and from an external information processing apparatus. For example, the communication unit 11 is connected to a predetermined network N (see FIG. 2) in a wired or wireless manner and sends and receives information to and from the content distribution device 100.

### Input Unit 12

The input unit 12 receives various operations from a user. For example, the input unit 12 may also receive various operations from a user via a display screen (for example, the output unit 13) by using a touch panel function. Furthermore, the input unit 12 may also receive various operations performed by a button provided in the terminal device 10 or a keyboard or a mouse connected to the terminal device 10.

### Output Unit 13

The output unit 13 is a display screen of a tablet terminal or the like, is implemented by, for example, a liquid crystal display or an organic electro-luminescence (EL) display, and is a display device for displaying various kinds of information.

### Storage Unit 14

The storage unit 14 is implemented by, for example, a semiconductor memory device, such as a random access memory (RAM) or a flash memory, or a storage device, such as a hard disk or an optical disk. The storage unit 14 stores therein, for example, information, such as a program, related to an application installed in the terminal device 10. Furthermore, the storage unit 14 according to the embodiment includes, as illustrated in FIG. 3, the advertisement information storage unit 141.

### Advertisement Information Storage Unit 141

The advertisement information storage unit 141 according to the embodiment stores therein various kinds of information related to advertisements. FIG. 4 is a diagram illustrating an example of an advertisement information storage unit according to the embodiment. The advertisement information storage unit 141 illustrated in FIG. 4 has items, such as “advertisement ID”, “advertisement content”, “unit price”, and the like.

The “advertisement ID” indicates identification information for identifying an advertisement. The “advertisement content” indicates advertisement content submitted from an advertiser. FIG. 4 illustrates an example in which conceptual information, such as “AC20”, is stored in the “advertisement content”; however, in practice, a still image, a moving image, text data, a URL, a file path name indicating a storage location of the above described image or the data, or the like is stored. The “unit price” indicates a cost (an amount of money) about a display of an associated advertisement. For example, the “unit price” indicates an amount of money charged to an advertiser when the associated advertisement is displayed. An advertiser may sometimes ask an agency for a work on submission of a manuscript. For example, it is assumed that the expression of “advertiser” is a concept including not only an advertiser but also an agency.

For example, the example illustrated in FIG. 4 indicates that the content of the advertisement identified by the advertisement ID “AD20” (advertisement AD20) is the advertisement content AC20 and indicates that the unit price thereof is “100 (yen)”. For example, in the example illustrated in FIG. 4, the unit price “100 (yen)” is used as a floor price. Furthermore, in the example illustrated in FIG. 4, the unit price “100 (yen)” is illustrated; however, the unit price may also be encrypted by the control information PG11 and concealed from a user or the like who uses the terminal device 10.

Furthermore, the information is not limited to that described above and the advertisement information storage unit 141 may also store therein various kinds of information in accordance with purposes. For example, the advertisement information storage unit 141 may also store therein identification information “advertiser ID” for identifying an advertiser. Furthermore, for example, the advertisement information storage unit 141 may also store therein a “product name” that indicates a product name targeted for an advertisement or a service name thereof. Furthermore, as information for identifying each product, the advertisement information storage unit 141 may also store therein not only the “product name” but also information on a “product ID” for identifying a product.

### Control Unit 15

The control unit 15 is a controller and is implemented by, for example, a central processing unit (CPU), a micro processing unit (MPU), or the like, executing various kinds of programs, which are stored in a storage device, such as the storage unit 14, included in the terminal device 10, by using a RAM as a work area. For example, these various kinds of programs include an application program that performs a determination process. Furthermore, the control unit 15 is a controller and is implemented by, for example, an integrated circuit, such as an application specific integrated circuit (ASIC), a field programmable gate array (FPGA), or the like.

As illustrated in FIG. 3, the control unit 15 includes an acquiring unit 151, a requesting unit 152, a determination unit 153, a displaying unit 154, and a sending unit 155 and implements or executes functions or operations of the determination process described later. Furthermore, the internal configuration of the control unit 15 is not limited to the configuration illustrated in FIG. 3 but may also be another configuration as long as the control unit 15 performs the determination process described later. Furthermore, a connection relation of each of the processing units included in the control unit 15 is not limited to the connection relation illustrated in FIG. 3 and any other connection relations may also be used.

### Acquiring Unit 151

The acquiring unit 151 acquires various kinds of information. For example, the acquiring unit 151 acquires various kinds of information from the storage unit 14 including the advertisement information storage unit 141 or the like. Furthermore, the acquiring unit 151 may also acquire various kinds of information from an external information processing apparatus.

For example, the acquiring unit 151 acquires various kinds of information from the content distribution device 100, the first type advertisement distribution server 50, and the second type advertisement distribution server 51. For example, the acquiring unit 151 acquires content from the content distribution device 100. Furthermore, for example, the acquiring unit 151 acquires the first advertisement from the first type advertisement distribution server 50. Furthermore, for example, the acquiring unit 151 acquires the second advertisement from the second type advertisement distribution server 51.

For example, the acquiring unit 151 acquires various operations that are input, via the input unit 12, by a user who uses the terminal device 10. For example, in accordance with an input performed by a user who uses the terminal device 10, the acquiring unit 151 acquires content from the content distribution device 100.

For example, the acquiring unit 151 acquires the first advertisement from the first type advertisement distribution server that has a predetermined relationship with the content that includes a predetermined ad spot displayed on the terminal device 10. For example, the acquiring unit 151 acquires the first advertisement from the first type advertisement distribution server in which the content is set as the advertisement distribution target. For example, the acquiring unit 151 acquires the first advertisement from the first type advertisement distribution server that is used by a providing source that has a predetermined relationship with a providing source that distributes the content. For example, the acquiring unit 151 acquires the first advertisement from the first type advertisement distribution server that is used by the providing source, which provides content, to provide an advertisement distribution service.

### Requesting Unit 152

The requesting unit 152 requests various kinds of information. For example, the requesting unit 152 makes various requests to the content distribution device 100, the first type advertisement distribution server 50, and the second type advertisement distribution server 51. For example, the requesting unit 152 requests the content distribution device 100 to distribute content. Furthermore, for example, the requesting unit 152 requests the first type advertisement distribution server 50 to distribute an advertisement. Furthermore, for example, the requesting unit 152 requests the second type advertisement distribution server 51 to distribute an advertisement. Furthermore, the requesting unit 152 may also send various kinds of information by itself or may also allow the sending unit 155 to send various kinds of information.

For example, by sending amount-of-money information based on a condition about the first type advertisement distribution server, the requesting unit 152 requests distribution of an advertisement from the second type advertisement distribution server. For example, by sending, to the second type advertisement distribution server, a billing amount, as the amount-of-money information, that is billed to the first type advertisement distribution server when the first advertisement is displayed, the requesting unit 152 requests distribution of an advertisement from the second type advertisement distribution server. For example, by sending, to the second type advertisement distribution server, the amount-of-money information, as the floor price information, that indicates the lowest amount of money for a successful bid requested for an advertisement that is distributed by the second type advertisement distribution server, the requesting unit 152 requests distribution of the advertisement from the second type advertisement distribution server.

In the example illustrated in FIG. 1, the requesting unit 152 requests an advertisement to be displayed on the ad spot AR11 that is included in the content CT11 from the first type advertisement distribution server 50. In the example illustrated in FIG. 1, the requesting unit 152 requests an advertisement from the first type advertisement distribution server 50 by using the control information PG11. In the example illustrated in FIG. 1, by sending the information indicating the ad spot AR11 to the first type advertisement distribution server 50, the requesting unit 152 requests an advertisement from the first type advertisement distribution server 50.

In the example illustrated in FIG. 1, the requesting unit 152 requests an advertisement from the advertisement distribution platform AP1. In the example illustrated in FIG. 1, the requesting unit 152 requests an advertisement by sending information indicating the ad spot AR11 and information indicating that the floor price is “100 (yen)” to the second type advertisement distribution server 51 that belongs to the advertisement distribution platform AP1.

In the example illustrated in FIG. 1, the requesting unit 152 requests an advertisement from the first type advertisement distribution server 50 by sending the information indicating the ad spot AR11 to the first type advertisement distribution server 50. In the example illustrated in FIG. 1, the requesting unit 152 requests an advertisement by sending the information indicating the ad spot AR11 and the information indicating that the floor price is “100 (yen)” to the second type advertisement distribution server 51 that belongs to the advertisement distribution platform AP1.

Furthermore, for example, by sending amount-of-money information encrypted by a predetermined means to the second type advertisement distribution server, the requesting unit 152 requests distribution of an advertisement from the second type advertisement distribution server. Furthermore, for example, based on an association table that shares information with the second type advertisement distribution server and that indicates association between an amount of money and a predetermined symbol, by sending amount-of-money information in which a billing amount to be billed to the first type advertisement distribution server is encrypted to the second type advertisement distribution server, the requesting unit 152 requests distribution of an advertisement from the second type advertisement distribution server. Furthermore, for example, by sending, to the second type advertisement distribution server, the amount-of-money information that includes therein a first symbol, in which a billing amount is encrypted based on the first association table indicating association between an amount of money that is gradually increased at a first interval and a predetermined symbol, and a second symbol, in which a billing amount is encrypted based on the second association table indicating association between an amount of money that is gradually increased at a second interval that is shorter than the first interval and a predetermined symbol, the requesting unit 152 requests distribution of an advertisement from the second type advertisement distribution server. These points will be described later.

### Determination Unit 153

The determination unit 153 determines various kinds of information. For example, when the second advertisement has been acquired from the second type advertisement distribution server, the determination unit 153 determines to display the second advertisement on an ad spot, whereas, when the second advertisement has not been acquired from the second type advertisement distribution server, the determination unit 153 determines to display the first advertisement on an ad spot.

In the example illustrated in FIG. 1, the determination unit 153 determines an advertisement to be displayed in accordance with reception from the second type advertisement distribution server 51. In the example illustrated in FIG. 1, when the second advertisement has been acquired from the second type advertisement distribution server 51, the determination unit 153 determines to display the second advertisement on an ad spot. In the example illustrated in FIG. 1, the determination unit 153 determines the advertisement AD12 acquired from the second type advertisement distribution server 51 as the advertisement that is to be displayed on the ad spot AR11. In the example illustrated in FIG. 1, because the advertisement AD12 has been acquired, the determination unit 153 determines that the advertisement to be displayed on the ad spot AR11 in the content CT11 is the advertisement AD12. In the example illustrated in FIG. 1, for example, when the second advertisement has not been acquired from the second type advertisement distribution server 51, the determination unit 153 determines that the advertisement to be displayed on the ad spot AR11 in the content CT11 is the advertisement AD20.

### Displaying Unit 154

The displaying unit 154 displays various kinds of information. For example, the displaying unit 154 displays various kinds of information via the output unit 13. For example, the displaying unit 154 displays various kinds of information acquired by the acquiring unit 151 or various kinds of information determined by the determination unit 153. For example, the displaying unit 154 displays the advertisement determined by the determination unit 153. For example, if the determination unit 153 determines to display the first advertisement, the displaying unit 154 displays the first advertisement. For example, if the determination unit 153 determines to display the second advertisement, the displaying unit 154 displays the second advertisement.

In the example illustrated in FIG. 1, the displaying unit 154 displays the content CT11 that includes the ad spot AR11. In the example illustrated in FIG. 1, the displaying unit 154 displays the content CT11 in which the advertisement AD12 is arranged in the ad spot AR11. In the example illustrated in FIG. 1, the displaying unit 154 displays the advertisement AD12 related to FX on the ad spot AR11.

### Sending Unit 155

The sending unit 155 sends various kinds of information. For example, the sending unit 155 sends various kinds of information to an external device. For example, the sending unit 155 may also send various kinds of information to an external information processing apparatus in accordance with an operation that has been input from the input unit 12 by a user. For example, the sending unit 155 provides various kinds of information to the content distribution device 100, the first type advertisement distribution server 50, and the second type advertisement distribution server 51. For example, the sending unit 155 sends information that requests content to the content distribution device 100. For example, the sending unit 155 sends information that requests an advertisement to the first type advertisement distribution server 50. For example, by sending amount-of-money information to the second type advertisement distribution server 51, the sending unit 155 sends the information that requests an advertisement.

Furthermore, if the process, such as the determination process, performed by the control unit 15 described above is performed by a predetermined application, each of the units in the control unit 15 may also be implemented by, for example, a predetermined application. In the predetermined application, a predetermined SDK that performs the determination process may also be included. For example, the process, such as the determination process or the displaying process, that is performed by the control unit 15 may also be implemented by control information including JavaScript or the like. Furthermore, if the determination process or the displaying process is performed by a dedicated application, the control unit 15 may also include, for example, an application control unit that controls the predetermined application or the dedicated application.

### 3. Flow of the Determination Process

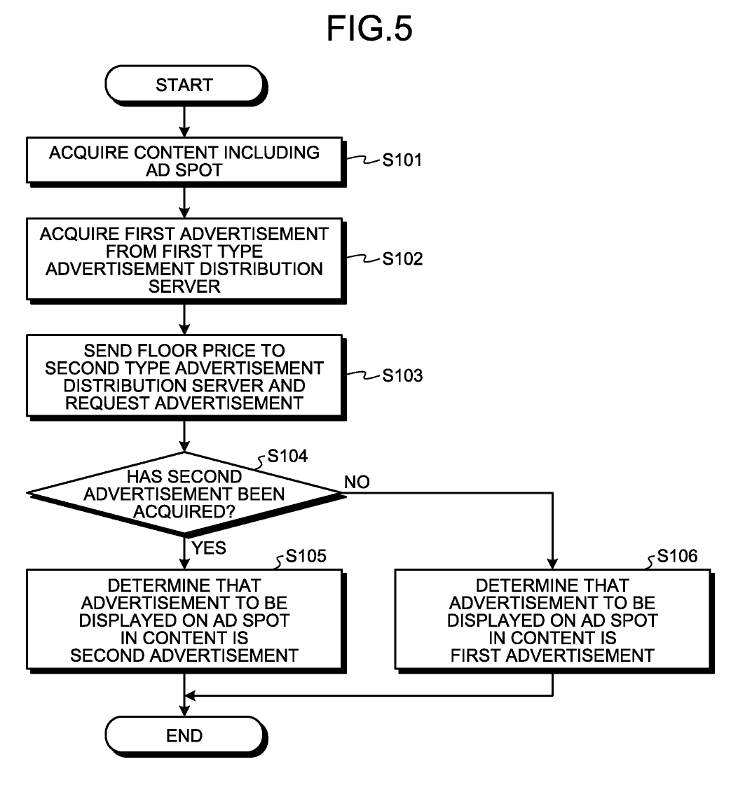

In the following, the flow of the determination process performed by the terminal device 10 according to the embodiment will be described with reference to FIG. 5. FIG. 5 is a flowchart illustrating an example of the determination process according to the embodiment.

As illustrated in FIG. 5, the terminal device 10 acquires the content including the ad spot (Step S101). In the example illustrated in FIG. 1, the terminal device 10 acquires the content CT11 including the ad spot AR11.

Then, the terminal device 10 acquires the first advertisement from the first type advertisement distribution server (Step S102). In the example illustrated in FIG. 1, the terminal device 10 acquires the advertisement AD20 from the first type advertisement distribution server 50.

Then, the terminal device 10 sends a floor price to the second type advertisement distribution server and requests an advertisement (Step S103). In the example illustrated in FIG. 1, the terminal device 10 sends the information indicating the floor price (100 yen) to the second type advertisement distribution server 51 and requests an advertisement.

Then, the terminal device 10 determines whether the terminal device 10 has acquired the second advertisement (Step S104). For example, if the terminal device 10 has acquired the second advertisement (Yes at Step S104), the terminal device 10 determines that the advertisement to be displayed on the ad spot in the content is the second advertisement (Step S105). Then, the terminal device 10 displays the second advertisement on the ad spot in the content. In the example illustrated in FIG. 1, because the terminal device 10 has acquired the advertisement AD12, the terminal device 10 determines that the advertisement to be displayed on the ad spot AR11 in the content CT11 is the advertisement AD12.

Furthermore, for example, if the terminal device 10 has not acquired the second advertisement (No at Step S104), the terminal device 10 determines that the advertisement to be displayed on the ad spot in the content is the first advertisement (Step S106). Then, the terminal device 10 displays the first advertisement on the ad spot in the content. In the example illustrated in FIG. 1, for example, if the terminal device 10 has not acquired the second advertisement from the second type advertisement distribution server 51, the terminal device 10 determines that the advertisement to be displayed on the ad spot AR11 in the content CT11 is the advertisement AD20.

### 4. Another Example of the Determination Process

In the example described above, a case has been described in which the advertisement distributed by the second type advertisement distribution server 51 is displayed; however, the terminal device 10 may also display the advertisement acquired from the first type advertisement distribution server 50. This point will be described with reference to FIG. 6. FIG. 6 is a diagram illustrating an example of the determination process according to the embodiment. Descriptions of the same points as those described in FIG. 1 will appropriately be omitted.

First, in the example illustrated in FIG. 6, the terminal device 10 sends, in accordance with an operation performed by a user, a request for content to the content distribution device 100 (Step S21). The content distribution device 100 that has received the request for content distributes the content that is to be displayed on the terminal device 10 (Step S22). For example, the content distribution device 100 distributes the content CT11 to the terminal device 10.

At Step S22, the terminal device 10 that has received the content CT11 requests an advertisement to be displayed on the ad spot AR11 in the content CT11 from the first type advertisement distribution server 50 (Step S23). For example, the terminal device 10 requests an advertisement from the first type advertisement distribution server 50 by using the control information PG11. In the example illustrated in FIG. 6, by sending the information indicating the ad spot AR11 to the first type advertisement distribution server 50, the terminal device 10 requests an advertisement from the first type advertisement distribution server 50.

The first type advertisement distribution server 50 that has received the request for an advertisement from the terminal device 10 distributes the first advertisement to the terminal device 10 (Step S24). In the example illustrated in FIG. 6, the first type advertisement distribution server 50 distributes the advertisement AD20 to the terminal device 10. Furthermore, in the example illustrated in FIG. 6, the first type advertisement distribution server 50 sends, to the terminal device 10, the information indicating that the unit price of the advertisement AD20 is “100 (yen)”. In the following, a description will be given in a case in which the terminal device 10 uses the unit price “100 (yen)” of the advertisement AD20 as a floor price that indicates the lowest amount of money for a successful bid as the right for displaying an advertisement on the ad spot AR11.

The terminal device 10 that has acquired the advertisement AD20 and the information indicating the unit price thereof from the first type advertisement distribution server 50 requests an advertisement from the advertisement distribution platform AP1 (Step S25). In the example illustrated in FIG. 6, by sending information indicating the ad spot AR11 and information indicating that the floor price is “100 (yen)” to the second type advertisement distribution server 51 that belongs to the advertisement distribution platform AP1, the terminal device 10 requests an advertisement.

The second type advertisement distribution server 51 that has acquired the request for an advertisement from the terminal device 10 requests a bid for an advertisement from each of the DSP devices 70 that belongs to the advertisement distribution platform AP1 with the minimum bid amount of money of “100 (yen)” (Step S26).

In the example illustrated in FIG. 6, regarding the ad spot AR11, the second type advertisement distribution server 51 requests a bid for an advertisement from the DSP device 70-1 with the minimum bid amount of money of “100 (yen)” (Step S26-1). Furthermore, in the example illustrated in FIG. 6, regarding the ad spot AR11, the second type advertisement distribution server 51 requests a bid for an advertisement from the DSP device 70-2 with the minimum bid amount of money of “100 (yen)” (Step S26-2). Furthermore, although not illustrated in FIG. 6, the second type advertisement distribution server 51 similarly requests a bid for an advertisement from the other DSP devices 70.

Then, the DSP device 70 that has acquired the bid request at Step S26 does not submit a bid for an advertisement to the second type advertisement distribution server 51 in a predetermined bid period (Step S27). In the example illustrated in FIG. 6, the DSP device 70-1 does not submit a bid for an advertisement to the second type advertisement distribution server 51 in a predetermined bid period (Step S27-1). In the example illustrated in FIG. 6, the DSP device 70-2 does not submit a bid for the advertisement to the second type advertisement distribution server 51 in a predetermined bid period (Step S27-2). Furthermore, although not illustrated in FIG. 6, the other DSP devices 70 do not submit a bid for an advertisement to the second type advertisement distribution server 51 in a predetermined bid period. Furthermore, by sending, to the second type advertisement distribution server 51, information indicating that a bid for an advertisement is not submitted, the DSP device 70 may also notify the second type advertisement distribution server 51 of not bidding for an advertisement.

Then, the second type advertisement distribution server 51 determines the second advertisement that is distributed to the ad spot AR11 (Step S28). In the example illustrated in FIG. 6, because there is no advertisement that has been bid from the DSP devices 70, the second type advertisement distribution server 51 determines that the second advertisement distributed to the ad spot AR11 is “null”.

At Step S28, the second type advertisement distribution server 51 that has determined the second advertisement to be “null” sends, to the first type advertisement distribution server 50, notification information indicating that there is no second advertisement to be distributed to the ad spot AR11 (Step S29).

The terminal device 10 that has received the notification information indicating that there is no second advertisement to be distributed to the ad spot AR11 determines, based on the reception from the second type advertisement distribution server 51, the advertisement to be displayed (Step S30-1). For example, if the terminal device 10 has not acquired the second advertisement from the second type advertisement distribution server 51, the terminal device 10 determines to display the first advertisement acquired from the first type advertisement distribution server 50 on the ad spot.

Consequently, in the example illustrated in FIG. 6, because the terminal device 10 has received the notification information indicating that there is no second advertisement from the second type advertisement distribution server 51, the terminal device 10 determines to display, on the ad spot AR11, the advertisement AD20 that is the first advertisement acquired from the first type advertisement distribution server 50. Then, the terminal device 10 displays the content CT11 in which the advertisement AD20 is arranged in the ad spot AR11 (Step S30-2). In the example illustrated in FIG. 6, the terminal device 10 displays the advertisement AD20 related to a game A on the ad spot AR11.

As described above, the terminal device 10 designates a floor price, requests an advertisement from the second type advertisement distribution server 51, and determines an advertisement to be displayed on the ad spot AR11 in accordance with a response from the second type advertisement distribution server 51, whereby the terminal device 10 can appropriately determine the advertisement to be displayed. Here, if the second type advertisement distribution server 51 has not distributed the second advertisement, this indicates that the second type advertisement distribution server 51 is not able to distribute an advertisement with a bid amount that is higher than the advertisement AD20 with a unit price of “100 (yen)” acquired from the first type advertisement distribution server 50. Thus, it is desirable to display the advertisement AD20 with the unit price of “100 (yen)” acquired from the first type advertisement distribution server 50 on the ad spot AR11 from the viewpoint of a profit of advertisement distribution to the content CT11. Accordingly, the terminal device 10 displays, on the ad spot AR11, the advertisement to be distributed from the first type advertisement distribution server 50 in which the normal content CT11 is set as the advertisement distribution target. Consequently, the determination system 1 can increase the profitability of the advertisement distribution.

### 5. Concealment of Information

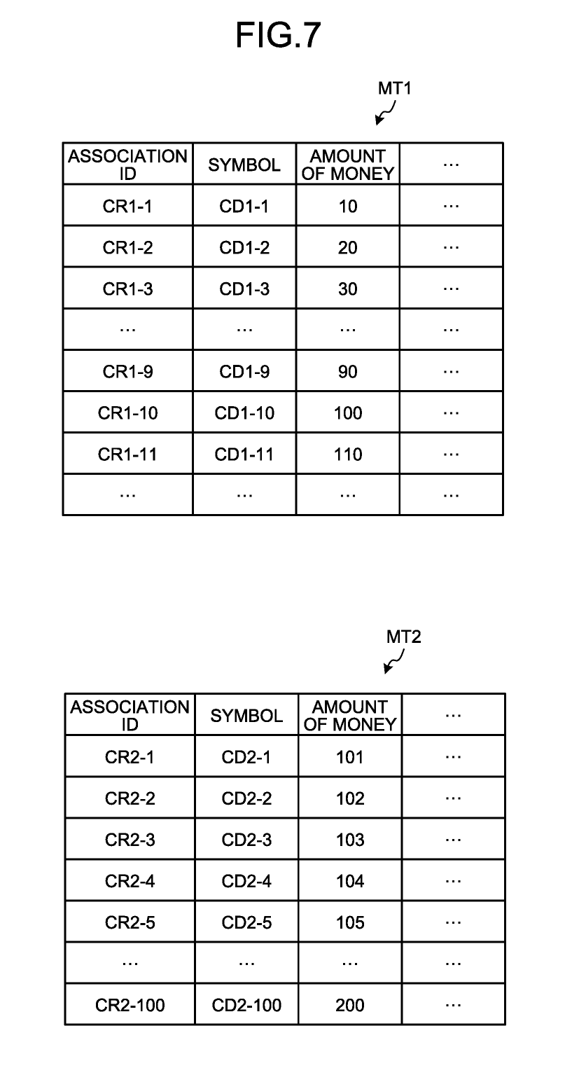

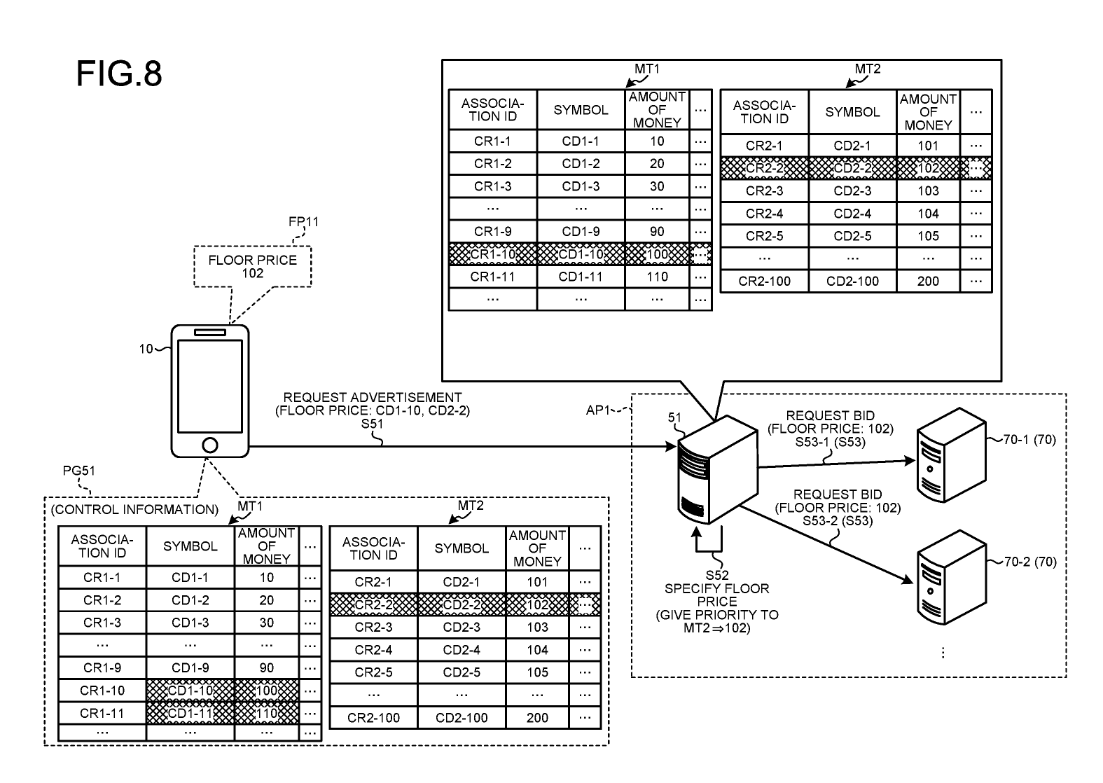

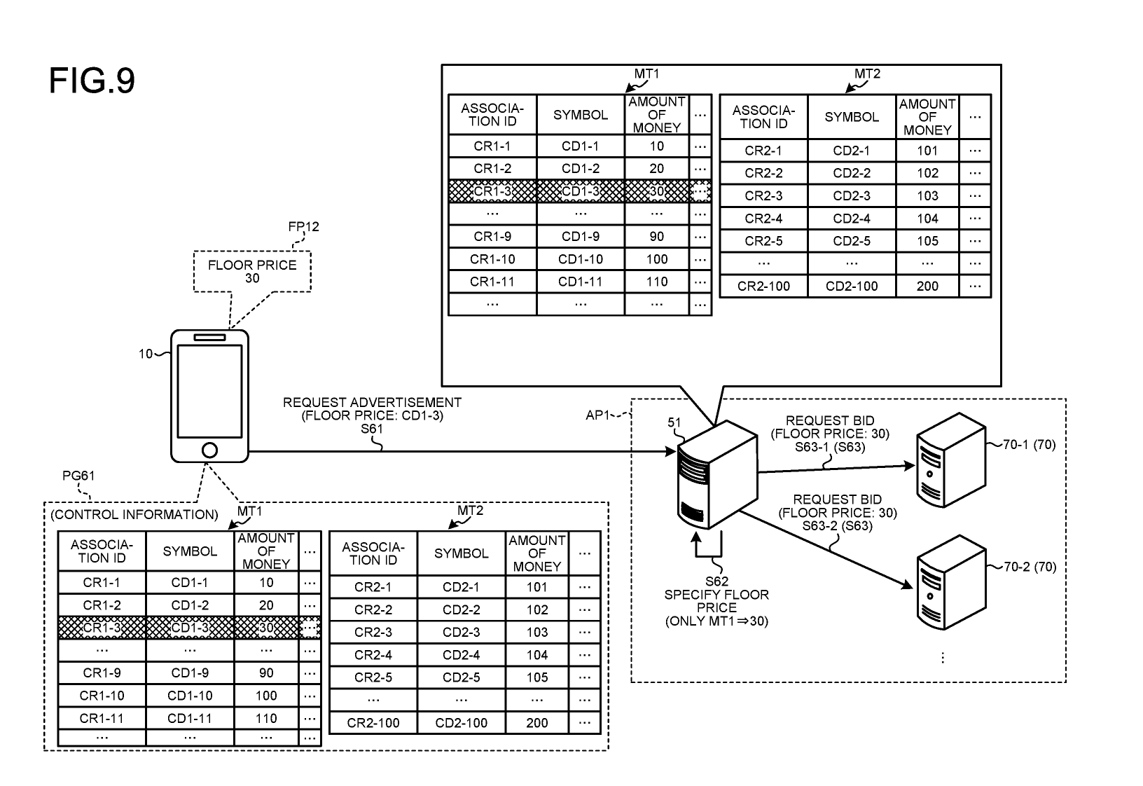

In the following, a method for concealing amount-of-money information in the determination system 1 according to the embodiment and sending the concealed information will be described with reference to FIGS. 7 to 9. FIG. 7 is a diagram illustrating an example of an association table according to the embodiment. FIG. 8 is a diagram illustrating an example of an advertisement request performed by using the association table according to the embodiment. FIG. 9 is a diagram illustrating an example of an advertisement request performed by using the association table according to the embodiment.

For example, in the determination system 1, at the time of communication, both the terminal device 10 and the second type advertisement distribution server 51 may also conceal the amount-of-money information (floor price) by using a first association table MT1 and a second association table MT2. Each of the first association table MT1 and the second association table MT2 illustrated in FIG. 7 is an association table that shares information with the terminal device 10 and the second type advertisement distribution server 51 and that indicates association between an amount of money and a predetermined symbol.

The first association table MT1 illustrated in FIG. 7 is the association table indicating the association between an amount of money that is gradually increased at a first interval (in increments of 10 yen) and a predetermined symbol. For example, the association identified by an association ID “CR1-1” in the first association table MT1 indicates that a symbol “CD1-1” is associated with an amount of money “10 (yen)”. Furthermore, for example, the association identified by an association ID “CR1-2” in the first association table MT1 indicates that a symbol “CD1-2” is associated with an amount of money “20 (yen)”. For example, the first association table MT1 illustrated in FIG. 7 stores therein 100 symbols associated with the respective amounts of money from 10 yen to 1000 yen in increments of 10 yen.

Furthermore, the second association table MT2 illustrated in FIG. 7 is the association table indicating the association between an amount of money, which is gradually increased at a second interval (in increments of 1 yen) that is shorter than the first interval, and a predetermined symbol. For example, the association identified by an association ID “CR2-1” in the second association table MT2 indicates that a symbol “CD2-1” is associated with an amount of money “101 (yen)”. Furthermore, for example, the association identified by an association ID “CR2-2” in the second association table MT2 indicates that a symbol “CD2-2” is associated with an amount of money “102 (yen)”. For example, the second association table MT2 illustrated in FIG. 7 stores therein 100 symbols associated with the respective amounts of money from 101 yen to 200 yen in increments of 1 yen.

In this way, by associating the amounts of money with the symbols by using two different intervals, the determination system 1 can reduce an increase in the number of symbols. For example, if 1 yen to 1000 yen are associated with symbols in increments of 1 yen, 1000 symbols (association) are needed. However, because the determination system 1 separately stores only the amount of money in the range (101 yen to 200 yen) that is needed to be in increments of 1 yen as in increments of 1 yen, the total number of symbols can be reduced to be 200.

Furthermore, as illustrated in FIG. 7, by allowing the first association table MT1 to include the associated range in which amounts of money are overlapped with those in the second association table MT2, the range of amounts of money in the second association table MT2 can be freely adjusted within the range of amounts of money in the first association table MT1. For example, in the example illustrated in FIG. 7, if the range of the amount of money from 301 yen to 400 yen in the second association table MT2 is desired to be set in increments of 1 yen, because the first association table MT1 includes the range of amounts of money from 101 yen to 200 yen, the second association table MT2 can be implemented only by changing the second association table MT2 in the range of 301 yen to 400 yen.

In the following, processes performed by using the association tables will be described with reference to FIGS. 8 and 9. Furthermore, the processes performed before the terminal device 10 requests an advertisement from the second type advertisement distribution server 51 are the same as those described with reference to FIG. 1; therefore, descriptions thereof will be omitted.

First, a case in which two symbols are sent will be described with reference to FIG. 8. In the example illustrated in FIG. 8, it is assumed that, as indicated by floor price information FP11, the floor price is “102 (yen)”. Furthermore, in the example illustrated in FIG. 8, it is assumed that the first association table MT1 and the second association table MT2 are included in control information PG51. For example, the control information PG51 is JavaScript (registered trademark) and includes a determination program that causes the terminal device 10 to execute the determination process.

For example, the terminal device 10 specifies the symbol associated with the amount of money “102 (yen)” in the first association table MT1. In the example illustrated in FIG. 8, the terminal device 10 indicates that the symbol associated with the amount of money “102 (yen)” in the first association table MT1 is a symbol “CD1-10” or a symbol “CD1-11”. Furthermore, the terminal device 10 may also indicate that the symbol associated with the amount of money “102 (yen)” in the first association table MT1 is one of the symbol CD1-10” and the symbol “CD1-11”. For example, if the terminal device 10 requests the advertisement with a billing amount higher than the floor price from the second type advertisement distribution server 51, the terminal device 10 may also indicate that the symbol associated with the amount of money “102 (yen)” in the first association table MT1 is the symbol “CD1-11”. Furthermore, in the example illustrated in FIG. 8, it is assumed that the terminal device 10 indicates that the symbol associated with the amount of money “102 (yen)” in the first association table MT1 is the symbol “CD1-10”.

For example, the terminal device 10 specifies the symbol associated with the amount of money “102 (yen)” in the second association table MT2. In the example illustrated in FIG. 8, the terminal device 10 indicates that the symbol associated with the amount of money “102 (yen)” in the second association table MT2 is the symbol “CD2-2”.

Then, by sending the symbol “CD1-10” and the symbol “CD2-2”, the terminal device 10 requests an advertisement from the second type advertisement distribution server 51 (Step S51). In this way, by sending the symbol “CD1-10” and the symbol “CD2-2” and by requesting an advertisement from the second type advertisement distribution server 51, the terminal device 10 can conceal the floor price at the time of communication.

Then, the second type advertisement distribution server 51 that has received the symbol “CD1-10” and the symbol “CD2-2” from the terminal device 10 specifies the floor price by using the first association table MT1 and the second association table MT2 (Step S52). In the example illustrated in FIG. 8, the second type advertisement distribution server 51 indicates that, by using the first association table MT1, the symbol “CD1-10” is associated with the amount of money “100 (yen)”. Furthermore, in the example illustrated in FIG. 8, the second type advertisement distribution server 51 indicates that, by using the second association table MT2, the symbol “CD2-2” is associated with the amount of money “102 (yen)”.

Furthermore, it is assumed that the second type advertisement distribution server 51 gives priority to the symbols that have shorter intervals and that are stored in the second association table MT2. Thus, in the example illustrated in FIG. 8, the second type advertisement distribution server 51 indicates that the floor price is the amount of money “102 (yen)” that is associated with the symbol “CD2-2” in the second association table MT2.

Then, the second type advertisement distribution server 51 requests, from the DSP device 70 that belongs to advertisement distribution platform AP1, a bid for an advertisement with the minimum bid amount of money of “102 (yen)” (Step S53).

In the example illustrated in FIG. 8, regarding the ad spot AR11, the second type advertisement distribution server 51 requests a bid for an advertisement with the minimum bid amount of money of “102 (yen)” from the DSP device 70-1 (Step S53-1). Furthermore, in the example illustrated in FIG. 8, regarding the ad spot AR11, the second type advertisement distribution server 51 requests a bid for an advertisement with the minimum bid amount of money of “102 (yen)” from the DSP device 70-2 (Step S53-2). Furthermore, although not illustrated in FIG. 8, the second type advertisement distribution server 51 similarly requests a bid for an advertisement from the other DSP devices 70.

In the following, a case in which two symbols are sent will be described with reference to FIG. 9. In the example illustrated in FIG. 9, as indicated by the floor price information FP12, it is assumed that the floor price is “30 (yen)”. Furthermore, in the example illustrated in FIG. 9, it is assumed that the first association table MT1 and the second association table MT2 are included in the control information PG61. For example, the control information PG61 is JavaScript and includes a determination program that causes the terminal device 10 to execute the determination process.

For example, the terminal device 10 specifies the symbol that is associated with the amount of money “30 (yen)” in the first association table MT1. In the example illustrated in FIG. 9, the terminal device 10 indicates that the symbol associated with the amount of money “30 (yen)” in the first association table MT1 is a symbol “CD1-3”.

Furthermore, for example, because the symbol associated with the amount of money “30 (yen)” is not present in the second association table MT2, the terminal device 10 indicates that the symbol is not present in the second association table MT2.

Then, by sending a symbol “CD1-3”, the terminal device 10 requests an advertisement from the second type advertisement distribution server 51 (Step S61). In this way, by sending the symbol “CD1-3” and by requesting an advertisement from the second type advertisement distribution server 51, the terminal device 10 can conceal the floor price at the time of communication. Furthermore, if the symbol is not present in the second association table MT2, by sending only the symbol “CD1-3” in the first association table MT1, the terminal device 10 can request an advertisement in a manner in which the second type advertisement distribution server 51 can specify the floor price.

Then, the second type advertisement distribution server 51 that has received the symbol “CD1-3” from the terminal device 10 specifies the floor price by using the first association table MT1 (Step S62). In the example illustrated in FIG. 9, the second type advertisement distribution server 51 uses the first association table MT1 and indicates that the symbol “CD1-3” is associated with the amount of money “30 (yen)”.

In the example illustrated in FIG. 9, because the symbol is not present in the second association table MT2, the second type advertisement distribution server 51 indicates that the floor price is the amount of money “30 (yen)” that is associated with the symbol “CD1-3” in the first association table MT1.

Then, the second type advertisement distribution server 51 requests a bid for an advertisement with the minimum bid amount of money of “30 (yen)” from the DSP device 70 that belongs to the advertisement distribution platform AP1 (Step S63).

In the example illustrated in FIG. 9, regarding the ad spot AR11, the second type advertisement distribution server 51 requests a bid for an advertisement with the minimum bid amount of money of “30 (yen)” from the DSP device 70-1 (Step S63-1). Furthermore, in the example illustrated in FIG. 9, regarding the ad spot AR11, the second type advertisement distribution server 51 requests a bid for an advertisement with the minimum bid amount of money of “30 (yen)” from the DSP device 70-2 (Step S63-2). Furthermore, although not illustrated in FIG. 9, the second type advertisement distribution server 51 similarly requests a bid for an advertisement from the other DSP devices 70.

### 6. Effects

As described above, the terminal device 10 according to the embodiment includes the acquiring unit 151, the requesting unit 152, and the determination unit 153. The acquiring unit 151 acquires a first advertisement (the “advertisement AD20” in the embodiment; the same applies hereinafter) from a first type advertisement distribution server (the “first type advertisement distribution server 50” in the embodiment; the same applies hereinafter) that has a predetermined relationship with content (the “CT11” in the embodiment; the same applies hereinafter) that includes a predetermined ad spot (the “ad spot AR11” in the embodiment; the same applies hereinafter) displayed on the terminal device 10. The requesting unit 152 requests, by sending amount-of-money information that is based on a condition related to the first type advertisement distribution server, distribution of an advertisement from a second type advertisement distribution server (the “second type advertisement distribution server 51” in the embodiment; the same applies hereinafter) that determines an advertisement to be distributed in accordance with a bid price of each advertisement and that distributes a second advertisement (for example, the “advertisement AD12” in the embodiment; the same applies hereinafter) when a bid price of the second advertisement satisfies the condition that is based on the amount-of-money information. The determination unit 153 determines, when the second advertisement has been acquired from the second type advertisement distribution server, to display the second advertisement on the ad spot and determines, when the second advertisement has not been acquired from the second type advertisement distribution server, to display the first advertisement on the ad spot.

Consequently, the terminal device 10 according to the embodiment can appropriately determine the advertisement to be displayed by determining, when the second advertisement has been acquired from the second type advertisement distribution server, to display the second advertisement on the ad spot and determining, when the second advertisement has not been acquired from the second type advertisement distribution server, to display the first advertisement on the ad spot.

Furthermore, in the terminal device 10 according to the embodiment, the acquiring unit 151 acquires the first advertisement from the first type advertisement distribution server that uses the content as a distribution target for the advertisement.

Consequently, the terminal device 10 according to the embodiment can appropriately determine the advertisement to be displayed by acquiring the first advertisement from the first type advertisement distribution server that uses the content as a distribution target for the advertisement.

Furthermore, in the terminal device 10 according to the embodiment, the acquiring unit 151 acquires the first advertisement from the first type advertisement distribution server that is used by a providing source that has a predetermined relationship with a providing source that distributes the content.

Consequently, the terminal device 10 according to the embodiment can appropriately determine the advertisement to be displayed by acquiring the first advertisement from the first type advertisement distribution server that is used by the providing source that has a predetermined relationship with the providing source that distributes the content.

Furthermore, in the terminal device 10 according to the embodiment, the acquiring unit 151 acquires the first advertisement from the first type advertisement distribution server that is used by a providing source, which distributes content, to provide an advertisement distribution service.

Consequently, the terminal device 10 according to the embodiment can appropriately determine the advertisement to be displayed by acquiring the first advertisement from the first type advertisement distribution server that is used by the providing source, which distributes content, to provide an advertisement distribution service.

Furthermore, in the terminal device 10 according to the embodiment, the requesting unit 152 requests distribution of the advertisement from the second type advertisement distribution server by sending, to the second type advertisement distribution server, the amount-of-money information as floor price information that indicates the lowest amount of money for a successful bid that is requested for the advertisement distributed by the second type advertisement distribution server.

Consequently, the terminal device 10 according to the embodiment can appropriately determine the advertisement to be displayed by sending the floor price information that indicates the lowest amount of money for a successful bid to the second type advertisement distribution server and by requesting distribution of the advertisement from the second type advertisement distribution server.

Furthermore, in the terminal device 10 according to the embodiment, the requesting unit 152 requests distribution of the advertisement from the second type advertisement distribution server by sending, to the second type advertisement distribution server, the amount-of-money information encrypted by a predetermined means.

Consequently, by sending, to the second type advertisement distribution server, the amount-of-money information encrypted by a predetermined means and requesting distribution of the advertisement from the second type advertisement distribution server, the terminal device 10 according to the embodiment can appropriately determine the advertisement to be displayed in a state in which the information on the amount of money related to a display of the advertisement is concealed from outside.

Furthermore, in the terminal device 10 according to the embodiment, the requesting unit 152 requests distribution of the advertisement from the second type advertisement distribution server by sending, to the second type advertisement distribution server based on an association table that shares information with the second type advertisement distribution server and that indicates association with an amount of money and a predetermined symbol, the amount-of-money information in which a billing amount billed to the first type advertisement distribution server is encrypted.

Consequently, by sending, to the second type advertisement distribution server based on the association table that indicates association with an amount of money and a predetermined symbol, the amount-of-money information in which the billing amount billed to the first type advertisement distribution server is encrypted and by requesting distribution of the advertisement from the second type advertisement distribution server, the terminal device 10 according to the embodiment can appropriately determine the advertisement to be displayed in a state in which the information on the amount of money related to the advertisement to be displayed is concealed from outside.

Furthermore, in the terminal device 10 according to the embodiment, the requesting unit 152 requests distribution of the advertisement from the second type advertisement distribution server by sending, to the second type advertisement distribution server, the amount-of-money information that includes a first symbol obtained by encrypting the billing amount based on a first association table that shares information with the second type advertisement distribution server and that indicates association between an amount of money that is gradually increased at a first interval and a predetermined symbol, and a second symbol obtained by encrypting the billing amount based on a second association table that shares information with the second type advertisement distribution server and that indicates association between an amount of money that is gradually increased at a second interval that is shorter than the first interval.

Consequently, by sending, to the second type advertisement distribution server based on the two association tables each of which indicates association between an amount of money and a predetermined symbol in different stages, the amount-of-money information in which the billing amount billed to the first type advertisement distribution server is encrypted and by requesting distribution of the advertisement from the second type advertisement distribution server, the terminal device 10 according to the embodiment can appropriately determine the advertisement to be displayed in a state in which the information on the amount of money related to a display of the advertisement is concealed from outside.

### 7. Program

The processes performed by the terminal device 10 and the content distribution device 100 described above are implemented by the determination program or the display program according to the present application. For example, the determination unit 153 in the terminal device 10 is implemented by executing, by a CPU, an MPU, or the like included in the terminal device 10 by using a RAM as a work area, a display procedure related to the determination program included in, for example, the control information PG11 or the like that executes the determination process. The other processing units in the terminal device 10 are also similarly implemented by executing each of the procedures related to the display program. For example, the displaying unit 154 in the terminal device 10 is implemented by executing, by the CPU, the MPU, or the like included in the terminal device 10 by using a RAM as a work area, the display procedure related to the display program included in, for example, the control information PG11 or the like that executes the determination process. The other processing units in the terminal device 10 are also implemented by similarly executing each of the procedures by the display program.

Furthermore, the processes performed by the terminal device 10 and the content distribution device 100 according to the present application do not need to be implemented by the determination program or the display program. For example, information related to other than the terminal device 10 may also be acquired by an operating system (OS) included in the terminal device 10. Namely, instead of the determination program or the display program itself executing the process performed by the terminal device 10 described above, the process performed by the terminal device 10 described above may also be performed by, for example, receiving data acquired by the OS (for example, data that is used to display an advertisement or the like).

### 8. Hardware Configuration

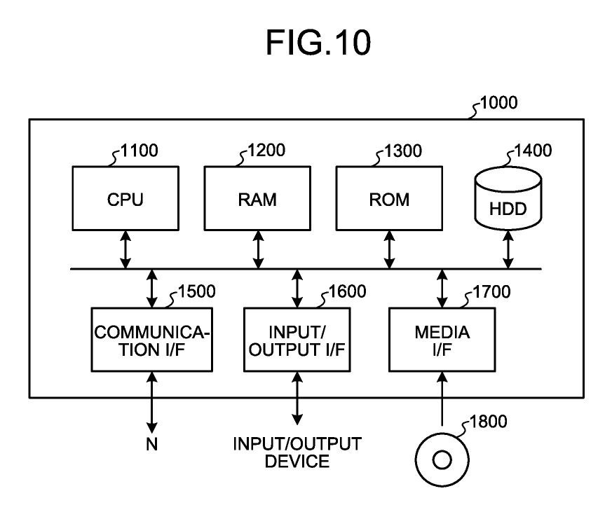

The terminal device 10 according to the embodiment described above is implemented by a computer 1000 having the configuration illustrated in, for example, FIG. 10. FIG. 10 is a hardware configuration diagram illustrating an example of a computer that implements the function of the terminal device. The computer 1000 includes a CPU 1100, a RAM 1200, a read only memory (ROM) 1300, a hard disk drive (HDD) 1400, a communication interface (I/F) 1500, an input/output interface (I/F) 1600, and a media interface (I/F) 1700.

The CPU 1100 operates based on a program stored in the ROM 1300 or the HDD 1400 and controls each of the units. The ROM 1300 stores therein a boot program that is executed by the CPU 1100 when the computer 1000 is started up, a program that depends on hardware of the computer 1000, or the like.

The HDD 1400 stores therein a program executed by the CPU 1100, data used by the program, or the like. The communication interface 1500 receives data from other devices via a predetermined network N, sends the data to the CPU 1100, and sends data generated by the CPU 1100 to other devices via the predetermined network N.

The CPU 1100 controls an output device, such as a display or a printer, or an input device, such as a keyboard or a mouse via the input/output interface 1600. The CPU 1100 acquires data from the input device via the input/output interface 1600. Furthermore, the CPU 1100 outputs the generated data to the output device via the input/output interface 1600.

The media interface 1700 reads a program or data stored in a recording medium 1800 and provides the program or the data to the CPU 1100 via the RAM 1200. The CPU 1100 loads the program from the recording medium 1800 into the RAM 1200 via the media interface 1700 and executes the loaded program. The recording medium 1800 is, for example, an optical recording medium, such as a digital versatile disc (DVD) or a phase change rewritable disk (PD), a magneto optical recording medium, such as a magneto-optical disk (MO), a tape medium, a magnetic recording medium, a semiconductor memory, or the like.

For example, when the computer 1000 functions as the terminal device 10 according to the embodiment, the CPU 1100 in the computer 1000 implements the functions of the control unit 15 by executing a program loaded into the RAM 1200. The CPU 1100 in the computer 1000 reads the program from the recording medium 1800 and executes the program. For another example, the program may also be acquired from other devices via the predetermined network N.

In the above, embodiments of the present invention have been described in detail based on the drawings; however the embodiments are described only by way of an example. In addition to the embodiments in disclosure of invention, the present invention can be implemented in a mode in which various modifications and changes are made in accordance with the knowledge of those skilled in the art.

### 9. Others

Of the processes described in the embodiment, the whole or a part of the processes that are mentioned as being automatically performed can also be manually performed, or the whole or a part of the processes that are mentioned as being manually performed can also be automatically performed using known methods. Furthermore, the flow of the processes, the specific names, and the information containing various kinds of data or parameters indicated in the above specification and drawings can be arbitrarily changed unless otherwise stated. For example, the various kinds of information illustrated in each of the drawings are not limited to the information illustrated in the drawings.

The components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions.

Furthermore, each of the processes described in the embodiments may be appropriately used in combination as long as the processes do not conflict with each other.

Furthermore, the “components (sections, modules, units)” described above can be read as “means”, “circuits”, or the like. For example, an acquiring unit can be read as an acquiring means or an acquiring circuit.

According to an aspect of an embodiment, an advantage is provided in that it is possible to appropriately determine an advertisement to be displayed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A determination method performed by a computer comprising:
acquiring a first advertisement from a first type advertisement distribution server that has a predetermined relationship with content that includes a predetermined ad spot displayed on a terminal device;
requesting, by sending amount-of-money information that is based on a condition related to the first type advertisement distribution server, distribution of an advertisement from a second type advertisement distribution server that determines an advertisement to be distributed in accordance with a bid price of each advertisement and that distributes a second advertisement when a bid price of the second advertisement satisfies the condition that is based on the amount-of-money information; and
determining, when the second advertisement has been acquired from the second type advertisement distribution server, to display the second advertisement on the ad spot and determining, when the second advertisement has not been acquired from the second type advertisement distribution server, to display the first advertisement on the ad spot.

2. The determination method according to claim 1, wherein the acquiring includes acquiring the first advertisement from the first type advertisement distribution server that uses the content as a distribution target for the advertisement.

3. The determination method according to claim 1, wherein the acquiring includes acquiring the first advertisement from the first type advertisement distribution server that is used by a providing source that has a predetermined relationship with a providing source that distributes the content.

4. The determination method according to claim 1, wherein the acquiring includes acquiring the first advertisement from the first type advertisement distribution server that is used by the providing source, which distributes the content, to provide an advertisement distribution service.

5. The determination method according to claim 1, wherein the requesting includes requesting distribution of the advertisement from the second type advertisement distribution server by sending, to the second type advertisement distribution server, a billing amount, as the amount-of-money information, that is billed to the first type advertisement distribution server when the first advertisement is displayed.

6. The determination method according to claim 1, wherein the requesting includes requesting distribution of the advertisement from the second type advertisement distribution server by sending, to the second type advertisement distribution server, the amount-of-money information as floor price information that indicates the lowest amount of money for a successful bid that is requested for the advertisement distributed by the second type advertisement distribution server.

7. The determination method according to claim 1, wherein the requesting includes requesting distribution of the advertisement from the second type advertisement distribution server by sending, to the second type advertisement distribution server, the amount-of-money information encrypted by a predetermined means.

8. The determination method according to claim 1, wherein the requesting includes requesting distribution of the advertisement from the second type advertisement distribution server by sending, to the second type advertisement distribution server based on an association table that shares information with the second type advertisement distribution server and that indicates association between an amount of money and a predetermined symbol, the amount-of-money information in which the billing amount billed to the first type advertisement distribution server is encrypted.

9. The determination method according to claim 8, wherein the requesting includes requesting distribution of the advertisement from the second type advertisement distribution server by sending, to the second type advertisement distribution server, the amount-of-money information that includes a first symbol obtained by encrypting the billing amount based on a first association table that shares information with the second type advertisement distribution server and that indicates association between an amount of money that is gradually increased at a first interval and a predetermined symbol and a second symbol obtained by encrypting the billing amount based on a second association table that shares information with the second type advertisement distribution server and that indicates association between an amount of money that is gradually increased at a second interval that is shorter than the first interval and a predetermined symbol.

10. A determination apparatus comprising:
an acquiring unit that acquires a first advertisement from a first type advertisement distribution server that has a predetermined relationship with content that includes a predetermined ad spot displayed on a terminal device;
a requesting unit that requests, by sending amount-of-money information that is based on a condition related to the first type advertisement distribution server, distribution of an advertisement from a second type advertisement distribution server that determines an advertisement to be distributed in accordance with a bid price of each advertisement and that distributes a second advertisement when a bid price of the second advertisement satisfies the condition that is based on the amount-of-money information; and
a determination unit that determines, when the second advertisement has been acquired from the second type advertisement distribution server, to display the second advertisement on the ad spot and that determines, when the second advertisement has not been acquired from the second type advertisement distribution server, to display the first advertisement on the ad spot.

11. A non-transitory computer-readable storage medium having stored therein a determination program that causes a computer to execute a process comprising:
acquiring a first advertisement from a first type advertisement distribution server that has a predetermined relationship with content that includes a predetermined ad spot displayed on a terminal device;
requesting, by sending amount-of-money information that is based on a condition related to the first type advertisement distribution server, distribution of an advertisement from a second type advertisement distribution server that determines an advertisement to be distributed in accordance with a bid price of each advertisement and that distributes a second advertisement when a bid price of the second advertisement satisfies the condition that is based on the amount-of-money information; and
determining, when the second advertisement has been acquired from the second type advertisement distribution server, to display the second advertisement on the ad spot and determining, when the second advertisement has not been acquired from the second type advertisement distribution server, to display the first advertisement on the ad spot.
